(19) United States
(12) Patent Application Publication
(10) Pub. No.: US 2017/0061401 A1
(43) Pub. Date: Mar. 2, 2017

(54) Mobile Application For Waiting Queue Prioritization Applicable To Retail And Restaurant Industries

(71) Applicant: Maxim Artemenko, Brighton, MA (US)

(72) Inventor: Maxim Artemenko, Brighton, MA (US)

(21) Appl. No.: 15/046,783

(22) Filed: Feb. 18, 2016

Related U.S. Application Data
(60) Provisional application No. 62/212,008, filed on Aug. 31, 2015.

(51) Int. Cl. G06Q 20/10; G06Q 20/32

(52) U.S. Cl. CPC G06Q 20/10; G06Q 20/3278; G06Q 20/3224

(57) ABSTRACT

In one embodiment, a method of prioritizing an individual's placement in a waiting queue comprise receiving, from the user of a mobile device, a request for queue prioritization. The mobile device then scans a unique identifier representing a place of business. Based on the unique identifier, a participating location is identified. It is then determined whether the user has sufficient funds to prioritize placement in the queue. If the user does have sufficient funds, an indication is provided on a display of the mobile device that the user has prioritized placement in the queue.

This application claims priority of U.S. Provisional Application Ser. No. 62/212,008 filed Aug. 31, 2015, the disclosure of which is incorporated herein by reference.

### FIELD OF THE DISCLOSURE

The present disclosure relates generally to waiting queue management. In particular, the present disclosure relates to a mobile application for prioritizing a waiting queue based on the needs of the individuals within the queue.

### BACKGROUND

The modern world is a busy place. Typical working professionals, including hourly employees, salaried employees, students, and the like are constantly in a hurry. Often, these individuals are able to structure their day such that they have enough time to accomplish everything that needs to be done. For example, individuals may leave for work a little earlier in the morning to stop for coffee and to have breakfast.

However, even the best laid plans may go awry. The car may not start. Traffic may be present. An individual may get involved in a car accident or fender bender. These unexpected occurrences have drastic effects on an individual's day, causing the individual to lose time based on the unexpected occurrence, which requires forfeiting certain activities. Often, these forfeited activities include skipping meals, such as breakfast or lunch. Unfortunately, missing a meal may result in decreased productivity due to the individual being hungry and/or tired.

Further, busy individuals may encounter long waiting queues at certain establishments. Often, the waiting queue is long enough that an individual may not have sufficient time available to wait. This issue can be compounded by unexpected events occurring, such as those described above. Further, the waiting queue is typically inefficient; various individuals within the queue may not mind waiting, whereas those truly in a hurry experience anguish.

Accordingly, there is a need for improvements in individual time management and waiting queues that do not suffer from the above described issues.

### SUMMARY

The present disclosure results, in part, from the realization that the problem of insufficient time can be solved by a waiting queue prioritization method and system that can prioritize the waiting queue based upon the time needs of the individuals within the queue. In certain embodiments, the waiting queue prioritization system can be embodied as a mobile application. Individuals who are in a hurry can reflect their need for prioritization by paying a fee. Paying the fee allows the individuals to prioritize their placement in the queue, or to enter a separate queue only for prioritized individuals. Transactions can be performed via the mobile application. In one embodiment, an individual who is in a hurry can approach a location identifier within a participating location, scan a code with the mobile application, pay a fee to prioritize placement in the waiting queue, and use the mobile application to indicate to the participating location that the individual has requested and paid for prioritization.

### BRIEF DESCRIPTION OF THE DRAWINGS

The following figures depict certain illustrative embodiments of the methods and systems described herein, in which like numerals refer to like elements. These depicted embodiments are to be understood as illustrative of the disclosed methods and systems and not as limiting in any way.

FIG. 1 is a block diagram illustrating an embodiment of a waiting queue prioritization system according to the disclosure;

FIG. 2 is a perspective view of a location identifier according to one embodiment of the disclosure;

FIG. 3 is a block diagram illustrating embodiments of applications and databases useful in a waiting queue prioritization system according to the disclosure;

FIGS. 4A-C are front views of the display of a mobile device executing a mobile application according to the disclosure as a user navigates and searches for a participating location;

FIGS. 5A-B are front views of the display of FIGS. 4A-C illustrating examples of information related to the user of the mobile device;

FIG. 6 is a block diagram illustrating another embodiment of a waiting queue prioritization system according to the disclosure;

FIG. 7 is a flow diagram illustrating an embodiment of a method of prioritizing the placement of an individual within a queue according to an embodiment of the disclosure; and

FIGS. 8A-E are front views of the display of FIGS. 4A-C illustrating prioritizing the placement of an individual with a queue using a mobile device.

### DETAILED DESCRIPTION OF THE DISCLOSURE

The detailed description set forth below in connection with the appended drawings is intended as a description of embodiments and does not represent the only forms which may be constructed and/or utilized. However, it is to be understood that the same or equivalent functions and sequences may be accomplished by different embodiments that are also intended to be encompassed within the spirit and scope of the disclosure, such as queue prioritization methods and systems using different mobile devices and applications. Moreover, the present disclosure relates to more than simply a queue management system. The disclosure discloses and teaches a new waiting queue management system with a payment system allowing for reprioritization of the queue based on the needs of the individuals within the queue, which requires the participation of an additional intermediary serving a unique role. The present disclosure teaches multiple substantial inventive steps, including the use of unique location identifiers, which allow people to advance or skip long waiting queues at their discretion for a fee, thus resulting in people getting to their ultimate destinations faster.

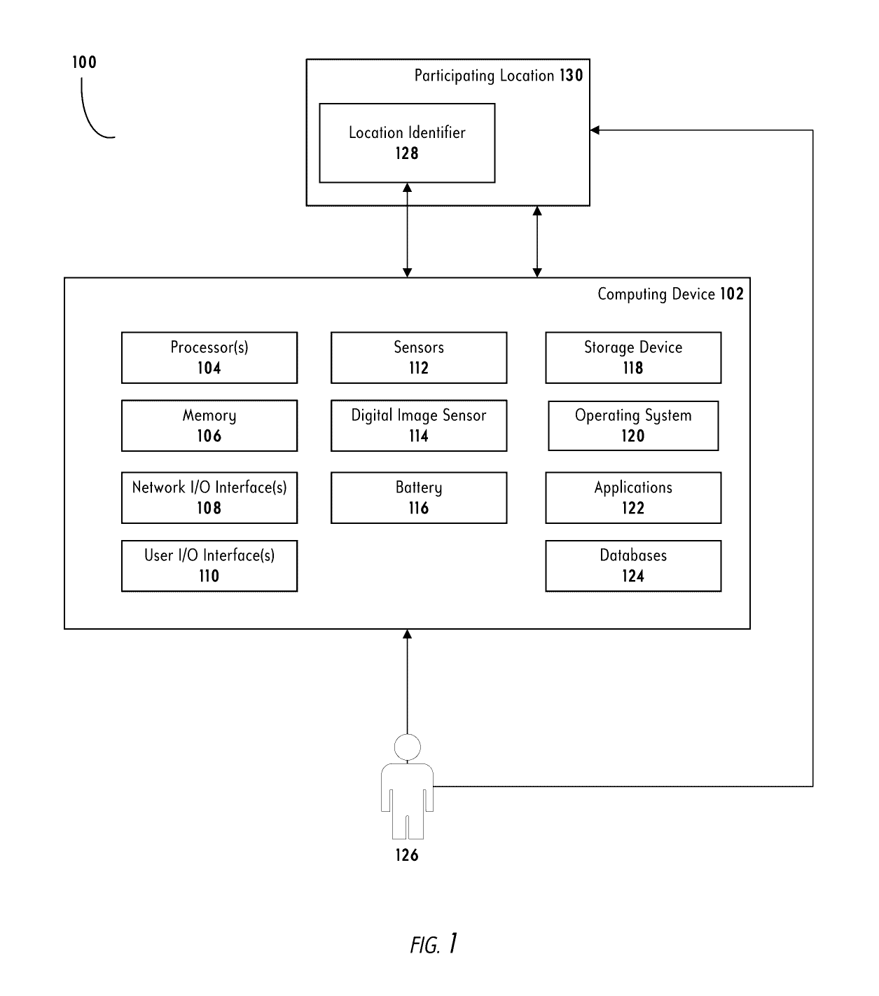

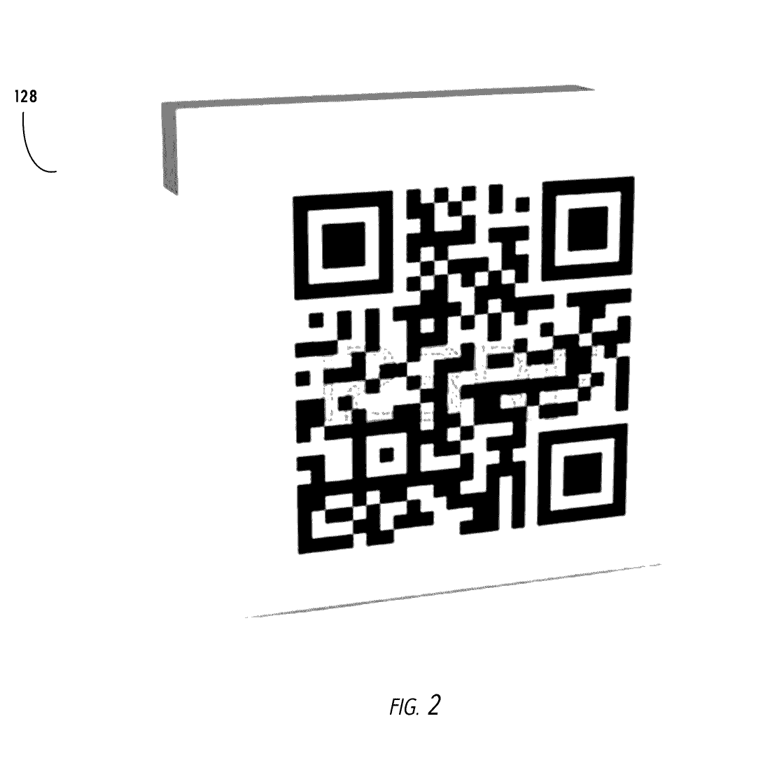

FIG. 1 is a block diagram illustrating an example embodiment of a waiting queue optimization system 100 suitable for practicing exemplary embodiments of the present disclosure. The waiting queue optimization system 100 may be used for re-prioritizing a waiting queue based on the needs of the individuals within the queue, or allowing individuals in the waiting queue to enter a prioritized queue. For example, the waiting queue optimization system 100 may be configured to accept payment by an individual within the queue to prioritize that individual's placement within the queue.

As shown in this embodiment, the system 100 can comprise a computing device 102, which may include processor(s) 104, memory 106, network input/output (I/O) interfaces 108, and user I/O interfaces 110. The computing device 102 can also include a variety of sensors 112, including a digital image sensor 114, and may be powered by a battery 116. A storage device 118, such as a hard drive flash drive, DVD, or CD-ROM, may be used for storing an operating system 120, a plurality of applications 122, and a plurality of databases 124. End users, such as a user 126, can interact with the computing device 102 directly via the user I/O interfaces 110. Further, the computing device 102 can interact with a particular business 130, retail establishment, or location via a location identifier 128.

Depending on particular implementation requirements of the present disclosure, the computing device 102 may be any type of computing system, such as a mobile device, cell phone, smart phone, tablet device, workstation, server, desktop computer, personal digital assistant, and the like. In some embodiments, all or parts of the computing device 102 may be wearable, e.g., as a component of a wrist watch, smart glasses, or other article of clothing. The computing device 102 may be embodied as a stand-alone system, or as a component of a larger electronic system. In certain embodiments, the waiting queue optimization system can comprise multiples of computing devices 102.

The processor(s) 104 may include hardware or software based logic to execute instructions on behalf of the computing device 102. For example, depending on specific implementation requirements, the processor(s) 104 may include a microprocessor; single or multiple cores for executing software stored in the memory 106; or other hardware or software components for controlling the computing device 102. The processor(s) 104 may be in communication with other components of the waiting queue optimization system 100, such as the memory 106, network I/O interfaces 108, user I/O interfaces 110, sensors 112, and storage device 118, for example, via a local bus.

The computing device 102 may access an external network or other computing devices via one or more network I/O interfaces 108. The network I/O interfaces 108 allow the computing device 102 to communicate with other computers or devices, and can comprise either hardware or software interfaces between equipment or protocol layers within a network. For example, the network I/O interfaces 108 may comprise Ethernet interfaces, frame relay interfaces, cable interfaces, DSL interfaces, token ring interfaces, wireless interfaces, cellular interfaces, and the like.

An end user, such as the user 126, may interact with the computing device 102 and waiting queue optimization system 100 via one or more user I/O interfaces 110. The user I/O interfaces 110 may comprise any input or output devices that allow an end user to interact with the computing device 102. For example, input devices can comprise a touchscreen, keyboard, microphone, camera, mouse, touchpad, trackball, five-way switch, joystick, and/or any combination thereof. Output devices can comprise a screen, display, speaker, printer, and/or any combination thereof. Thus, the end user may interact with the device by speaking, tapping, gesturing, or using a combination of multiple input modes. In turn, the computing device 102 or other component may respond with any combination of visual, aural, or haptic output. The computing device 102 may manage the user I/O interfaces 110 and provide a user interface to the end user by executing a stand-alone application, such as one of the applications 122. Alternately, a user interface may be provided by an operating system executing on the computing device 102, such as the operating system 120.

Additionally, the computing device 102 may contain a number of sensors 112 that can monitor variables regarding an end user, the computing device 102, and/or a local environment. Sensors 102 may include sensors that monitor the electromagnetic spectrum, device orientation, acceleration, present location of the computing device 102, and/or a user's heart rate. Accordingly, the sensors 112 may comprise an infrared sensor, gyroscope, accelerometer, biosensors, cameras, GPS, or any other sensor capable of sensing light, motion, temperature, magnetic fields, gravity, humidity, moisture, vibration, pressure, sound, electrical fields, or other aspects of the natural environment. The sensors 102 can further comprise a digital image sensor 114, which can be configured to capture and process a digital image of the environment surrounding the computing device 102, such as the location identifier 128.

Further, the computing device 102 can comprise a battery 116 which is used to provide electrical power to all of the components of the device. In various embodiments, the battery 116 may be rechargeable, such as a lithium ion (Li-ion) or nickel metal hydride (NiMH) battery. The battery 116 may also be removable or single-use. Alternately, in certain embodiments the computing device 102 may lack a battery and rely on an exterior power source.

The storage device 118 may further comprise an operating system 120 and a plurality of applications 122, which when loaded into memory 106 may be executed by processor(s) 104. The operating system 120 can comprise any suitable operating system, including Android OS, iOS, Windows Phone OS, Symbian OS, Firefox OS, Windows, Linux, Mac OS, and the like. Applications 102 may be executed via the operating system 120 and therefore may make use of any component of the computing device 102 or waiting queue optimization system 100. While in this embodiment, the applications 122 execute on the computing device 102, in certain embodiments applications may be located on an external server or access data stored on external storage. In such cases, the computing device 102 may access applications 122 through a network via the network I/O interfaces 110.

Applications 122 can comprise any kind of application, and may communicate and exchange data with other applications executing on the computing device 102. For example, applications 122 may relate to processing of images captured by the digital image sensor 114 and/or prioritizing placement in a waiting queue. Still other embodiments may include applications 122 related to social networking, sports, GPS navigation, e-mail, shopping, music, or movies. Further, applications 122 may communicate and exchange data with other applications executing on the computing device 102.

In some instances, applications 122 can include an application for determining the geographic location of the device 102. For example, a location application can communicate with a remote satellite (e.g., via the sensors 112) to determine a set of geographic coordinates of the device 122. Upon receiving the geographic coordinates, the location application can forward the coordinates to any application executing on the device 102 that wishes to know the current location of the device 102.

Databases 124 can comprise any kind of database or data storage for entry or storage of information related to the queue optimization system 100, such as member information, balances, locations, businesses, and the like. In certain embodiments, the databases 124 can comprise one or more relational databases comprising one or more relational database tables. For example, the databases 124 can comprise one or more MySQL, MariaDB, SQLite, Microsoft SQL Server, PostgreSQL, NoSQL, and/or other databases. However, in certain embodiments, all or portions of the databases 124 can simply be a flat file.

The participating location 130 can be any business or establishment that seeks to provide its customers with a way to prioritize their placement in a queue based on need. For example, in certain embodiments, the participating location 130 can be a restaurant, a coffee house, a delicatessen, a bar, a grocery store, and the like.

The location identifier 128 can comprise any means of identifying the location or identity of the participating location 130. For example, in certain embodiments, the location identifier 128 can be a specialized device positioned at the participating location 130, such as a sign or other posting that can be read by the digital image sensor 114 in order to identify the participating location 130. The specialized device 128 can also comprise a Quick Response Code (QR code). For example, as shown in the embodiment of FIG. 2, a QR code can be positioned on signage within the business location, such as on a cardboard or plastic cube, resulting in a “QR code cube.” While cardboard and plastic are disclosed, any type of material for placing the QR code or location identifier 128 can be used.

A QR code is a type of two-dimensional barcode that comprises a plurality of square dots arranged in a grid on a white background, which can be read by an imaging device and processed until the barcode can be appropriately interpreted. Unlike older, one-dimensional barcodes designed to be mechanically scanned by a narrow beam of light, a QR code can be detected by a 2-dimensional digital image sensor (such as the digital image sensor 114 of FIG. 1) and then be digitally analyzed by a processor (such as the processor 104 of FIG. 1). The processor 104 locates three distinctive squares at the corners of the image, and uses a smaller square or other set of squares near the fourth corner to normalize the image for size, orientation, and angle of viewing. The plurality of square dots throughout the QR code can then be converted to binary numbers and validated with an error-correcting algorithm.

QR codes can be used to store or represent a variety of types of information, such as text, a vCard contact, a Uniform Resource Locator (URL), or an e-mail or text message. Mobile devices can be used as a QR code scanner to read the code and convert it to a useful form, such as a URL. QR codes storing information can appear on almost any object in which users may desire more information. QR codes may also be linked to a particular location, such as a store or business. The application that scans the QR code can retrieve the location or geographical information by using GPS and/or cell phone tower triangulation, or the URL or other information encoded in the QR code itself is associated with a location.

However, certain embodiments may lack a location identifier 128. For example, in these embodiments, the computing device 102 may determine the identity of the participating location 130 based on the present location of the computing device 102, which may be determined, example, by a location application accessing geographic coordinates from the sensors 112.

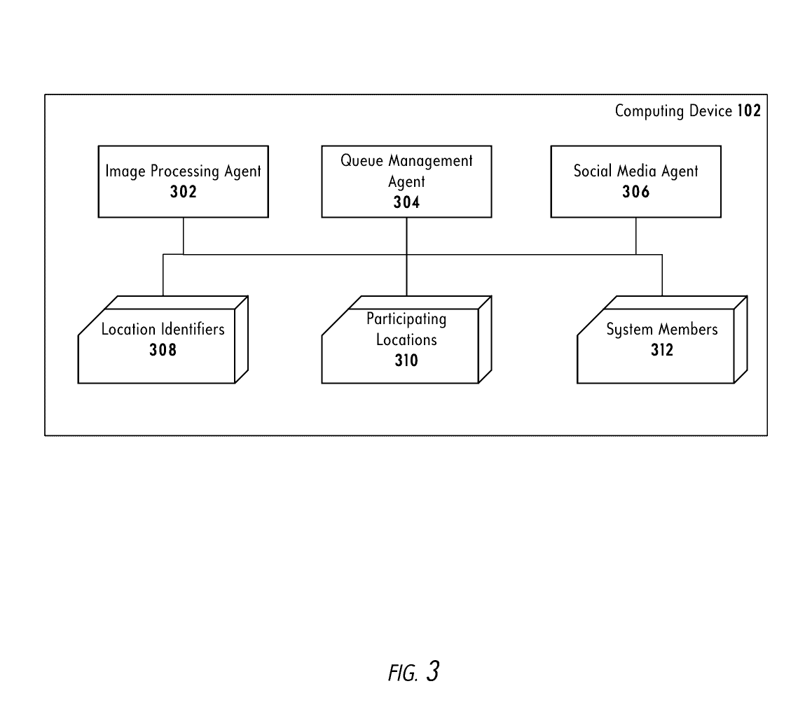

FIG. 3 illustrates embodiments of applications 122 and databases 124 according to an embodiment of the disclosure. As shown in this embodiment, applications 122 can comprise an image processing agent 302, a queue management agent 304, and a social media agent 306. Databases 124 can comprise a plurality of information items related to location identifiers 308; participating businesses 310; and system members 312. Each of the agents 302, 304, 306 can interact with each of the databases 308, 310, 312 in order to accomplish functions associated with the queue management system 100.

The image processing agent 302 can be configured to analyze a location identifier, such as the location identifier 128 of FIG. 1. For example, the image processing agent 302 can be configured to receive image information from the digital image sensor 114 of the computing device 102 and process the image information to determine the location of the business 130. As noted above, in certain embodiments, the location identifier 128 can be a QR code, which when processed yields the identity of the particular business participating in the queue optimization system 100.

The queue management agent 304 can be configured to prioritize an individual's placement in a waiting queue. For example, the queue management agent 304 can be configured to receive a request from an individual for queue prioritization, determine the location of the computing device from which the request was received, determine, based on the location, a participating location from which the computing device is located, determine whether the user has sufficient funds from which to prioritize placement in the queue, and then provide an indication of whether the customer is authorized to be prioritized within the queue.

The social media agent 306 can be configured to interact with various sources of social media, such as Twitter feeds, Facebook posts, Instagram posts, blog entries, and the like. For example, the social media agent 306 can be used to “like” establishments, such as the participating location 130. The social media agent 306 can also be used to “check in” to establishments, or to allow the individual 128 to post to Facebook, Instagram, and the like that he or she has prioritized placement on the waiting queue at a particular establishment, such as the participating location 130. In certain embodiments, posting to Facebook may include a predetermined sentence supplied by the participating location, such as “[individual] has just enjoyed an amazing ice cream at [participating location]!”.

In certain embodiments, the image processing agent 302, queue management agent 304, and social media agent 306 may execute entirely on the computing device 102. In other embodiments, the agents 302, 304, 306 may execute at least partially on external computing devices or systems.

Location identifiers 308 can comprise any means of identifying the location of a participating location, such as the participating location 130 of FIG. 1. As noted above, location identifiers 308 can comprise signs, postings, QR codes, and the like to enable the computing device 102 to identify the particular participating location 130 in which the computing device 102 is currently located.

Participating locations 310 can comprise information related to a plurality of participating locations enrolled in the waiting queue optimization system 100. As noted above, participating locations 310 can comprise restaurants, coffee houses, delicatessens, bars, grocery stores, and the like. Information related to each participating location can include the participating location's address, social media information, reviews, menu, and the like.

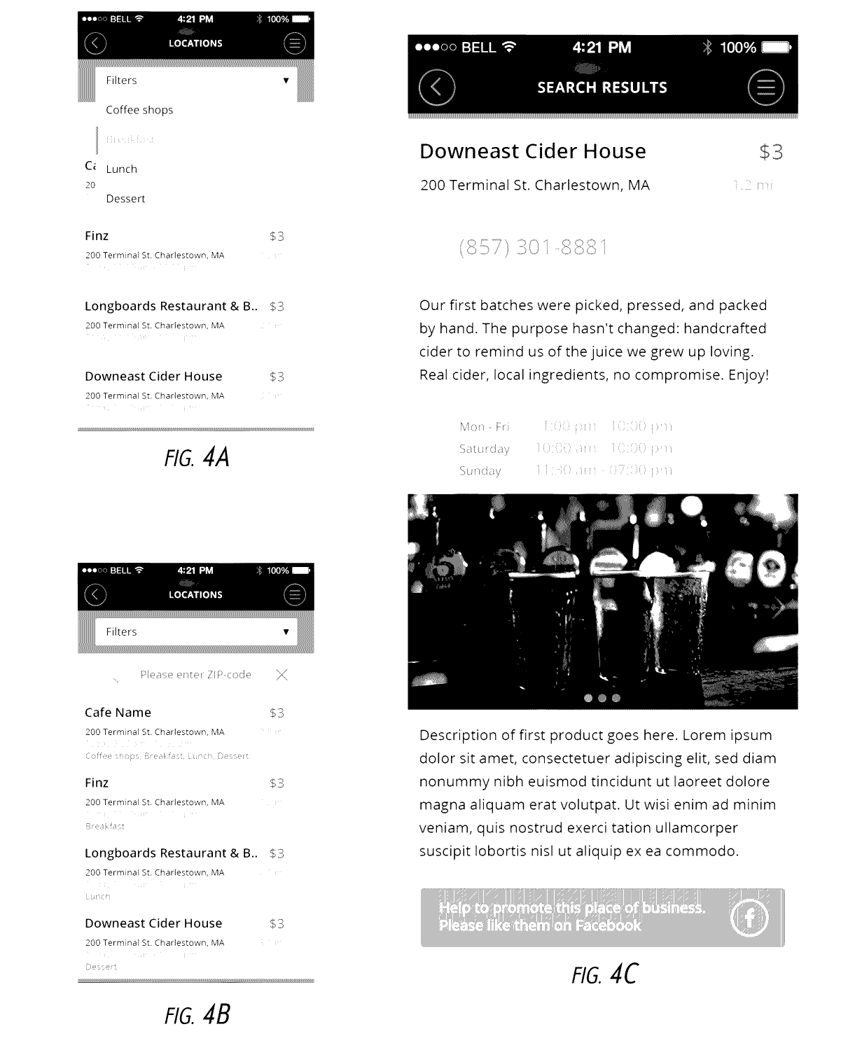

As shown in FIGS. 4A-C, in certain embodiments, information related to participating locations 310 can be available to an individual via the user I/O interfaces or display of a mobile device, such as the individual 126 and the user I/O interfaces 110 of FIG. 1. As shown in the embodiment of FIG. 4A, the user I/O interfaces can be configured to allow an individual to select establishments that sell a particular desired cuisine, such as coffee, breakfast, lunch, and/or dessert. As shown in the embodiment of FIG. 4B, the user I/O interfaces 110 can be configured to list a plurality of participating locations, and include information such as the store hours, location, and pricing of menu items. As shown in the embodiment of FIG. 4C, the user I/O interfaces 110 can be further configured to display information related to a selected establishment, such as its name; address; phone number; hours; and description. In certain embodiments, this information may include current news, specials, popular items, and other elements that provide a personalized page or listing for a particular participating location. Furthermore, the user I/O interfaces can 110 be integrated with social media services (i.e., via the social media agent 306), such as by including a “promote” button that “likes” the particular establishment on Facebook.

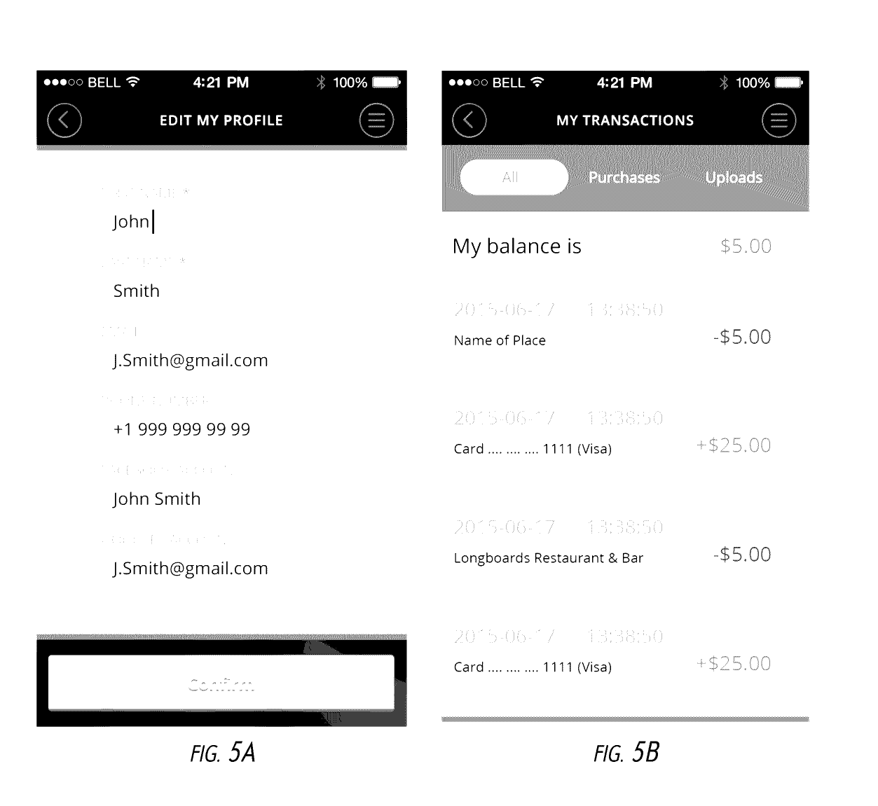

Returning to the embodiment of FIG. 3, members 312 can comprise information related to members, such as the individual 126, enrolled in the queue prioritization system 100. This information can include, without limitation, the individual's name, address, balance, credit card information, transaction history, and the like. As shown in the embodiment of FIG. 5A, the user I/O interfaces 110 can be configured to receive and display the user's name, email address, phone number, and account information for social media services such as Facebook and Google+. As shown in the embodiment of FIG. 5B, the user I/O interfaces 110 can further be configured to display the individual's transaction history, which can include the user's balance, a list of participating locations at which the user visited and prioritized his or her placement in the queue, and credits made via credit card.

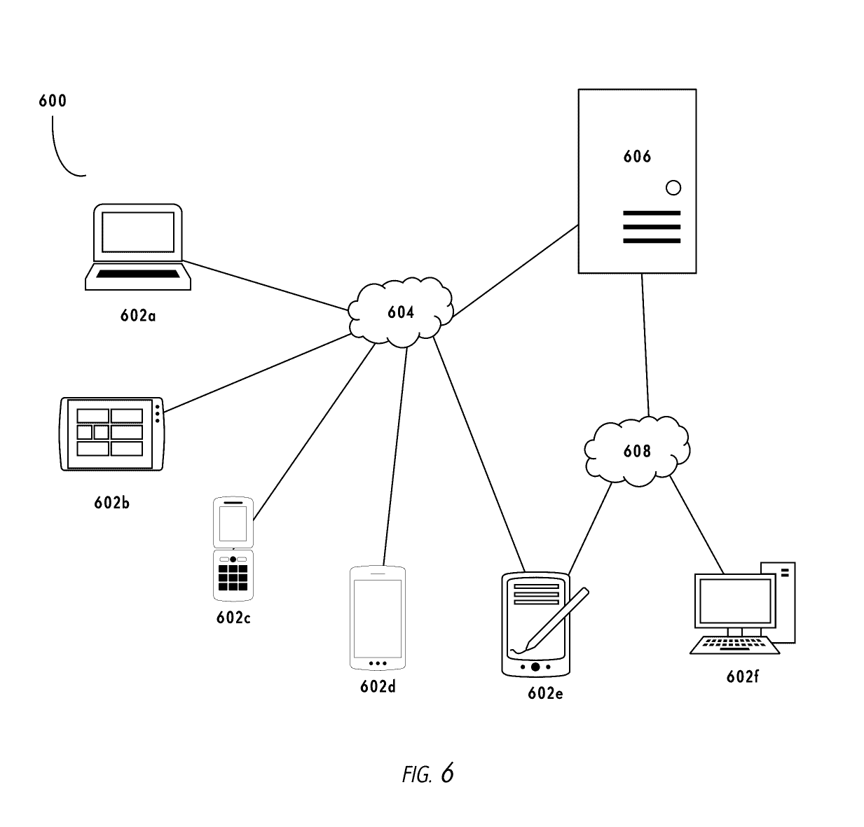

As noted above, portions of the queue optimization system 100 may be distributed between one or more devices or components. FIG. 6 illustrates another embodiment of a queue optimization system 600 according to the disclosure. In this embodiment, the queue optimization system 600 comprises a plurality of client computing devices 602a-f, a network 604, and at least one server computing device 606. As shown, the client computing devices 602a-f may comprise a laptop computer 602a, a slate device 602b, a mobile phone 602c, a smart phone 602d, a tablet device 602f, and a personal computer 602f. Each client computing device 602a-f may communicate with other devices and computers via a network 604. The network 604 can be any network, such as the Internet, a wired network, a cellular network, and a wireless network. In certain embodiments, each client computing device 602a-f may communicate with one or more storage systems, server computing devices (e.g., the server computing device 606), cloud computing systems, or other sites, systems, or devices hosting external services to access remote data or remotely executing applications. For example, external services can comprise social media applications, such as Facebook, Instagram, and the like. Further, client computing devices 602a-f may utilize multiple networks to access the server computing device 606, such as a local connection 608. The local connection 608 may be, for example, a serial, USB, local area network (LAN), wireless, Bluetooth, or other form of local connection physically close in proximity to the server computing device 606.

In this embodiment, the server computing device 606 may be configured to receive a request receive a request from an individual for queue prioritization, determine the location of the computing device from which the request was received, determine, based on the location, a participating location from which the computing device is located, determine whether the user has sufficient funds from which to prioritize placement in the queue, and then provide an indication of whether the customer is authorized to be prioritized within the queue, similar to the computing device 102 of FIG. 1. Accordingly, the server computing device 606 may comprise an image processing agent, queue management agent, and a social media agent, such as the agents 302, 304, 306 of FIG. 3. Thus, each of the client computing devices 602 may connect to the server computing device 606 over the network 604 or local connection 608 in order to identify a participating location at which the client computing device is placed, place a request for prioritization in the queue, receive authorization from prioritization, indicate a result to the participating location that the individual is authorized to be prioritized in the queue, or engage in some other form of interaction with the queue prioritization system 600.

However, as noted above, various components of the queue prioritization system 600 may be implemented either partly or wholly within the client computing devices 602. Accordingly, all or portions of the image processing agent 302, queue management agent 304, and social media agent 306 may execute locally on the client computing devices 602a-f. Similarly, information associated with location identifiers 308, participating locations 310, and system members 312 may be distributed across the client computing devices 602 and server computing device 606.

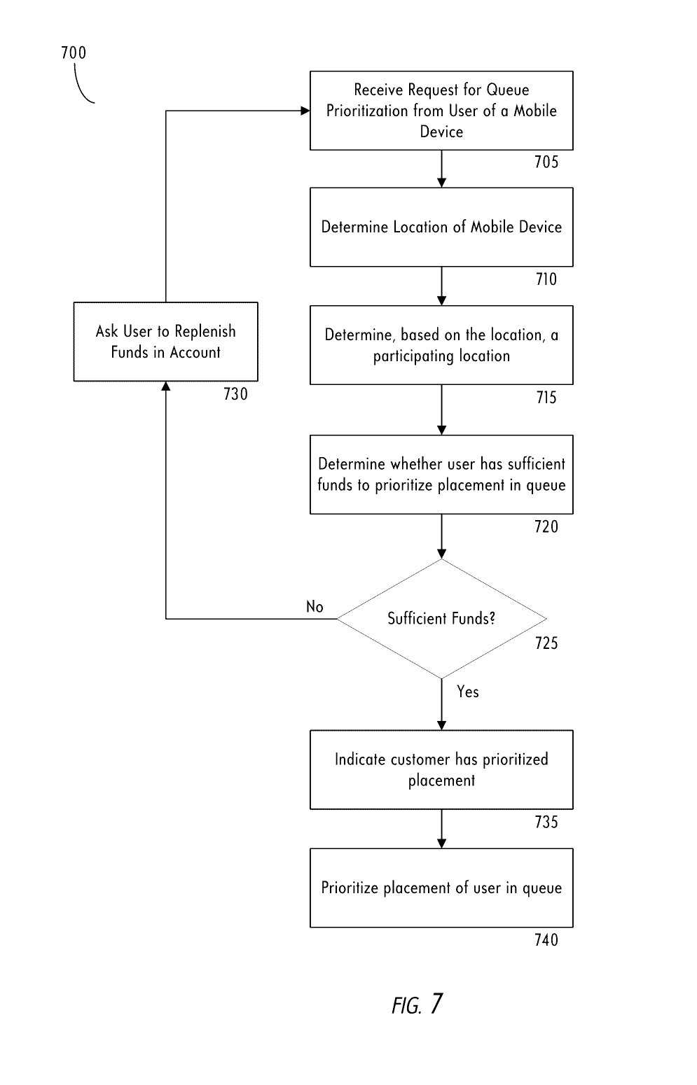

FIG. 7 depicts an embodiment of a method 700 of prioritizing placement in a queue according to an embodiment of the disclosure. The method 700 can be performed in the context of a queue prioritization system, such as the queue prioritization system 700 of FIG. 1. The method 700 can begin by receiving, by a queue management agent executing on a processor, a request for prioritization from a user of a mobile device (step 705). The location of the mobile device is then determined (step 710). Based on the location of the mobile device, a participating location is identified (step 715). The method then determines whether the user has sufficient funds to prioritize placement (step 720). If the user does not have sufficient funds (decision 725), the user is given the option of replenishing funds in the user's account, e.g., by using a credit card (step 730). However, if the user does have sufficient funds, an indication that the user has prioritized placement in the queue is provided to the mobile device (step 735). This indication can then be used by the participating location to prioritize placement of the user within a waiting queue at the location (step 740).

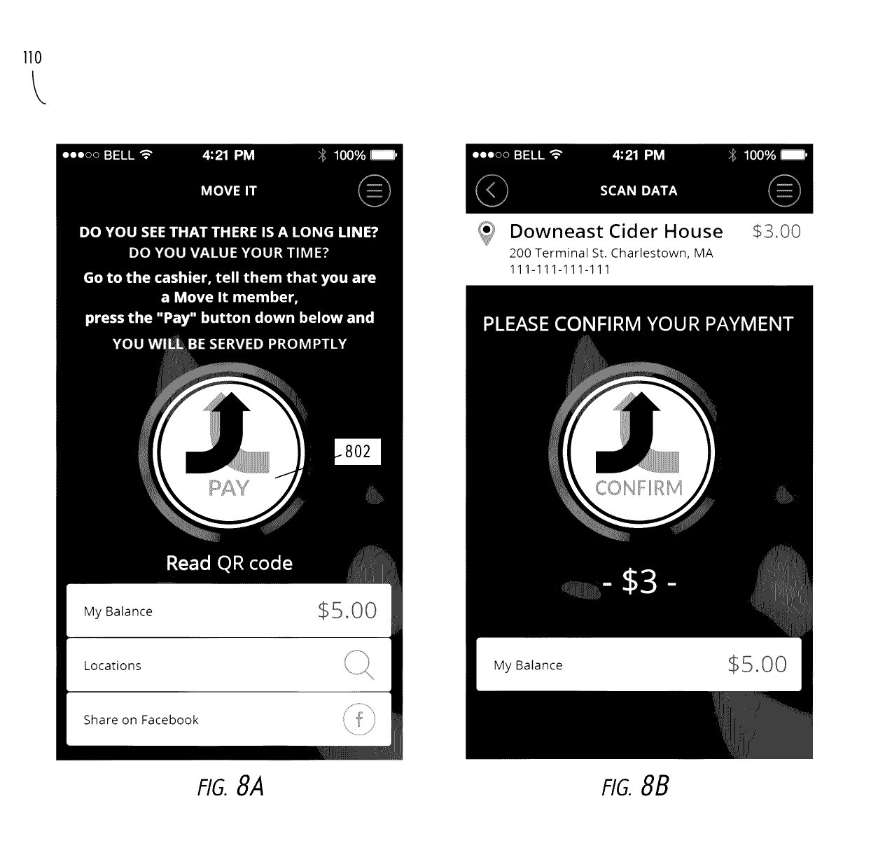

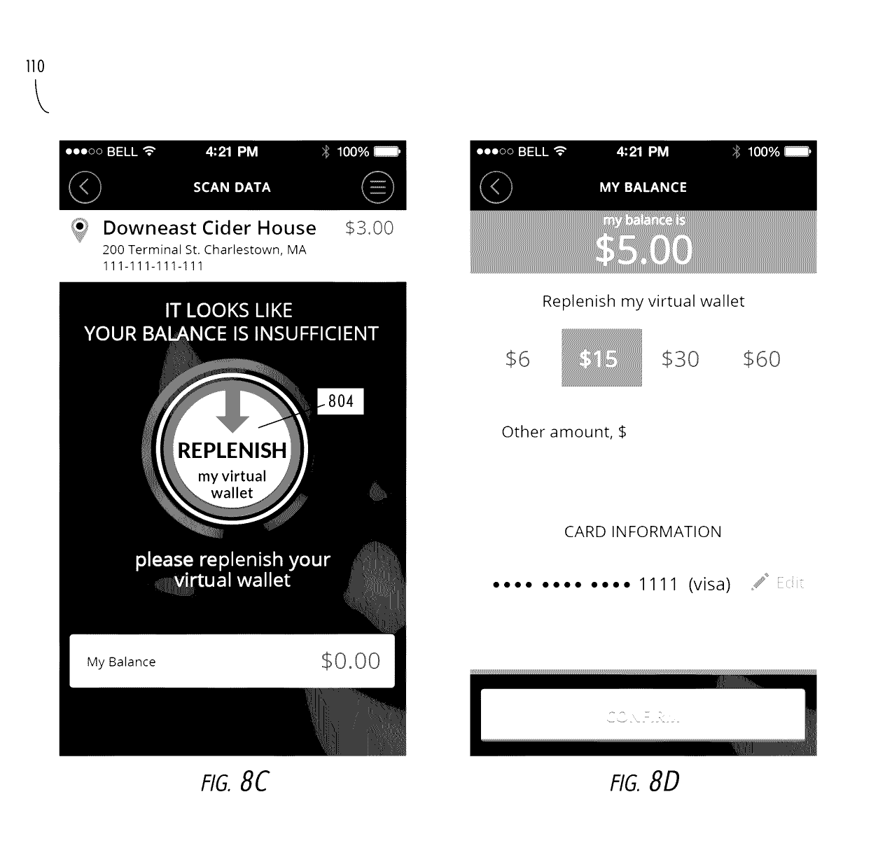

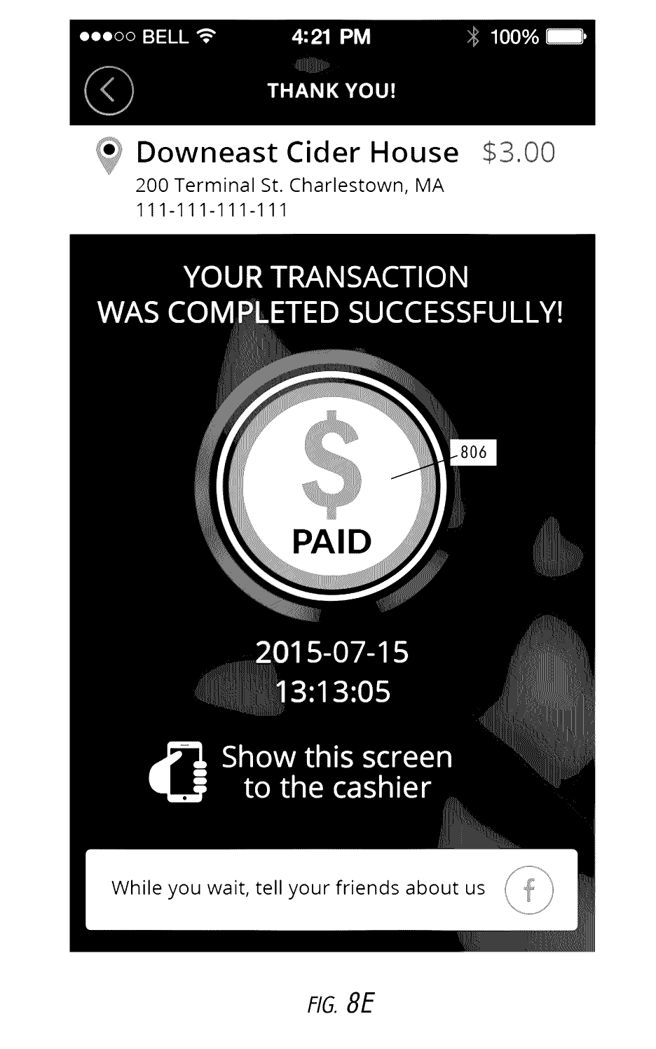

Receiving a request for queue prioritization from a user of a mobile device (step 705) can be performed in a variety of ways. As shown in the embodiment of FIG. 8A, the user, such as the individual 128 of FIG. 1, can interact with the user I/O interfaces of the mobile device in order to place a request for queue prioritization. In particular, the user can open an application on the mobile device to request prioritization by pressing a “pay” button 802 on the user I/O interface of the mobile device, such as the user I/O interface 110 of FIG. 1. In certain embodiments, the request may be forwarded to a server computer (e.g., the server computer 606 of FIG. 6) for additional processing.

Determining a location of the mobile device (step 715) can be done in a variety of ways. As previously noted, the user may scan a QR code cube with his or her mobile device to identify the particular participating location. However, in other embodiments, the mobile device may also determine the participating location based on location information, such as the current geographic coordinates of the device. In still further embodiments, the user may manually select a location from a list of participating locations available on the mobile device. As shown in the embodiment of FIG. 8B, the user may then confirm payment prior to queue prioritization. In certain embodiments, the mobile device may forward the QR code or other location identifier to a server computer (e.g., the server computer 606 of FIG. 6) for additional processing. For example, the server computer 606 may analyze the QR code to identify a participating location and then transmit this information back to the mobile device.

If the user has insufficient funds, the user may be prompted to replenish the funds in the user's account (step 730). As shown in the embodiment of FIG. 8C, the mobile device may display a “replenish” button 804 in order to provide the user with an option to increase the available balance on their account. As shown in the embodiment of FIG. 8D, the user may then be prompted to supply funds via a credit card, for example. In certain embodiments, the mobile device may communicate with a server computer (such as the server computer 606) to determine whether the user has sufficient funds and to perform a replenish transaction.

If payment has been verified, the user is then permitted to have prioritized placement in the waiting queue. As shown in the embodiment of FIG. 8E, indicating that the customer has prioritized placement (step 735) can be performed by displaying a “paid” symbol 806 on the user I/O interfaces 110 of the mobile device. The user may then display the “paid” symbol 806 to the present participating location such that the location can confirm that the user has prioritized placement. Accordingly, the user will be served next in the queue without needing to wait (step 740). However, in other embodiments, indicating that a customer has prioritized placement can be performed in a variety of ways. For example, in certain embodiments, the participating location may have a specialized device that displays the necessary indication. Further, in certain embodiments, authorization to display a “paid” symbol 806 may be received by the mobile device from a server computer, such as the server computer 606 of FIG. 6.

In these embodiments, the waiting queue prioritization system is a separate entity from the payment systems used by the participating locations. In this way, the waiting queue prioritization system can easily integrate with the participating location's primary sales system. However, in certain embodiments, the systems (i.e., the participating location's primary sales system and the waiting queue prioritization system) may be integrated together.

As previously noted, various benefits result from a waiting queue prioritization system according to embodiments of the disclosure. For example, businesses that participate as participating locations within the system can benefit from increased customer loyalty. For example, if customers know that they have the option to prioritize their placement in the queue at a particular establishment, should they need it, customers may be more likely to patronize that establishment. Further, as the prioritization system is designed to work with a plurality of businesses, customers do not need to carry a plurality of “loyalty cards” or other indicia that allows them to receive benefits from particular establishments. Moreover, an establishment participating in a waiting queue optimization system according to the present disclosure can experience significant savings by not having to pour resources into implementing customer loyalty programs.

Additionally, the presence of the waiting queue prioritization system may attract additional customers by streamlining the traditional waiting queue at a participating location. For example, often customers may enter an establishment only to realize that a waiting queue is too long to wait. In establishments utilizing a waiting queue prioritization management system according to the disclosure, the waiting queues will be segmented into one in which customers do not mind waiting, and another expedited queue for those who are not able to wait. Accordingly, the queues will be reduced, thus attracting additional customers.

In certain embodiments, a percentage of the fees received from individuals for prioritizing placement in a queue may also be diverted to the participating location. Accordingly, participating locations stand to substantially benefit from incorporating a waiting queue prioritization system according to embodiments of the disclosure.

Furthermore, businesses wishing to join a waiting queue prioritization system according to the disclosure only need to supply minimal details, which can include the business logo; several top selling items and relevant pictures; and a sales headline describing the business. In certain embodiments, the only hardware needed is a location identifier, such as the QR code cube described above.

Having described an embodiment of the technique described herein in detail, various modifications and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method, performed at least partially by a mobile device, of prioritizing an individual's placement in a waiting queue, comprising:
receiving, from the user of a mobile device, a request for queue prioritization;
scanning by the mobile device, a unique identifier representing a place of business;
identifying, based on the unique identifier, a participating location;
determining whether the user has sufficient funds to prioritize placement in the queue; and if the user has sufficient funds:
subtracting a queue prioritization fee from the funds; and
indicating, on a display of the mobile device, that the user has prioritized placement in the queue.

2. The method of prioritizing an individual's placement in a waiting queue of claim 1, wherein the unique identifier comprises a QR code positioned at the participating location.

3. The method of prioritizing an individual's placement in a waiting queue of claim 1, further comprising providing the indication of prioritized placement to the participating location.

4. A method of prioritizing an individual's placement in a waiting queue, comprising:
receiving, from the user of a mobile device, a request for queue prioritization;
receiving, from the mobile device, a unique identifier representing a place of business;
identifying, based on the unique identifier, a participating location;
determining whether the user has sufficient funds to prioritize placement in the queue; and
if the user has sufficient funds, indicating, to the mobile device, that the user has prioritized placement in the queue.

5. A system for prioritized waiting queue management, comprising:
a plurality of participating locations, wherein each location of the plurality of participating locations further comprises a location identifier;
a plurality of mobile devices, each mobile device configured to:
receive, from a user of the mobile device, a request for queue prioritization at a location of the plurality of locations;
scan the location identifier at the location;
send the request and location identifier to at least one server computer;
receive, from the at least one server computer, an indication that the user has prioritized placement in the queue; and
display, on a display of the mobile device, an indication that the user has prioritized placement; and
at least one server computer configured to:
receive, from a mobile device, a request for queue prioritization at a location of the plurality of participating locations and a location identifier;
identify, based on the unique identifier, the identity of the participating location;
determine whether the user of the mobile device has sufficient funds to prioritize placement in a queue;
if the user has sufficient funds, subtracting a queue prioritization fee from the user's funds, and indicating, to the mobile device, that the user has prioritized placement in the queue.
